(19) United States
(12) Patent Application Publication
(10) Pub. No.: US 2020/0201092 A1
(43) Pub. Date: Jun. 25, 2020

(54) ARRAY SUBSTRATE AND MANUFACTURING METHOD THEREOF AND DISPLAY PANEL

(71) Applicant: Wuhan China Star Optoelectronics Technology Co., Ltd., Wuhan (CN)

(72) Inventor: Wei WANG, (US)

(73) Assignee: Wuhan China Star Optoelectronics Technology Co., Ltd., Wuhan (CN)

(21) Appl. No.: 16/484,456

(22) PCT Filed: May 7, 2019
(86) PCT No.: PCT/CN2019/085757

§ 371 Date: Aug. 8, 2019

(30) Foreign Application Priority Data
Jul. 26, 2018 (CN) 201810830982.5

(51) Int. Cl. G02F 1/1339; G02F 1/1362; G02F 1/1333; G06K 7/14

(52) U.S. Cl. CPC G02F 1/1339; G06K 7/1417; G02F 1/133308; G02F 1/136277

(57) ABSTRACT

An array substrate and a manufacturing method thereof, and a display panel are provided. The array substrate includes a display area, and a non-display area disposed on a periphery of the display area. A pixel array disposed in the display area, and an identification area disposed in the non-display area. A ruler coordinate configured to locate a two-dimensional barcode is disposed at a boundary of the identification area, and a target location in the identification area is provided with the two-dimensional barcode and an identity character.

### FIELD OF INVENTION

The present disclosure relates to a display technology field, in particular, to an array substrate and a manufacturing method thereof, and a display panel.

### BACKGROUND OF INVENTION

In recent years, small and medium-sized liquid crystal displays have developed rapidly. In manufacturing an array substrate, based on use of a compact optical exposure machine, the array substrate needs to be coded using a code printer to identify each of the array substrates, wherein a two-dimensional barcode and an identity character for identifying the array substrate are disposed on the array substrate.

As product design changes, the narrow border needs to change the original two-dimensional barcode and the design of the identity character to the two-dimensional barcode mode. Referring to FIG. 1 and FIG. 2 for the structure of a current array substrate. The array substrate includes a display area 11 and a non-display area 12, wherein the non-display area includes an identification area 121, and the identification area is provided with a two-dimensional barcode 121b. Problems with existing array substrates include: first, after the two-dimensional barcode 121b is coded, the offset of the two-dimensional barcode 121b on the array substrate cannot be directly read, and the offset of the two-dimensional barcode cannot be directly obtained; second, the two-dimensional barcode cannot read the corresponding identity characters after taking photos on the camera recognition machine, and it is impossible to predict whether the two-dimensional barcode is accurate.

As a result, it is necessary to provide an array substrate and a manufacturing method thereof, and a display panel to solve the problems in the conventional technologies, as described above.

### SUMMARY OF INVENTION

An object of the present disclosure is to provide an array substrate and a manufacturing method thereof, and a display panel, which to solve the problem that the offset of the two-dimensional barcode cannot be directly obtained, and whether the two-dimensional barcode is accurate and unpredictable is generated.

To achieve the above objects, the present disclosure provides an array substrate, the array substrate comprises a display area, a non-display area disposed on a periphery of the display area, a pixel array disposed in the display area, and an identification area disposed in the non-display area, wherein a ruler coordinate configured to locate a two-dimensional barcode is disposed at a boundary of the identification area, and a target location in the identification area is provided with the two-dimensional barcode and an identity character separated from each other.

In the array substrate of the present disclosure, a shape of the identification area is a rectangle, and a scale of the ruler coordinate is disposed on at least one side of the boundary of the identification area.

In the array substrate of the present disclosure, the scale of the ruler coordinate is disposed on two adjacent sides of the boundary of the identification area.

In the array substrate of the present disclosure, a scale of the ruler coordinate is disposed in the identification area.

In the array substrate of the present disclosure, the scale of the ruler coordinate is separated from the identity character and the two-dimensional barcode.

In the array substrate of the present disclosure, a scale of the ruler coordinate is disposed outside the identification area.

In the array substrate of the present disclosure, the identity character includes at least two characters.

In the array substrate of the present disclosure, the identity character includes a first character and a second character combined with each other, the first character is an English alphabet, and the second character is an Arabic numeral.

To achieve the above objects, the present disclosure provides a manufacturing method of an array substrate, and the manufacturing method comprises S10, providing a substrate, wherein the substrate includes a display area and a non-display area disposed on a periphery of the display area; S20, coating a photoresist layer on the substrate and exposing, etching, and developing the substrate by using a target mask to form an identification area and a ruler coordinate in the non-display area, wherein the identification area includes an identity character, then stripping a remaining photoresist; and forming two-dimensional barcode on a target location in the identification area; wherein a pattern on the target mask corresponds to a pattern of the ruler coordinate and a pattern of the identity character, and the ruler coordinate is located at a boundary of the identification area.

In the manufacturing method of the present disclosure, a shape of the identification area is a rectangle, and a scale of the ruler coordinate is disposed on at least one side of the boundary of the identification area.

In the manufacturing method of the present disclosure, a scale of the ruler coordinate is disposed in the identification area.

In the manufacturing method of the present disclosure, the identity character includes a first character and a second character combined with each other, the first character is an English alphabet, and the second character is an Arabic numeral.

To achieve the above objects, the present disclosure provides a display panel, and the display panel includes an array substrate and a color film substrate oppositely arranged, wherein the array substrate comprises a display area, a non-display area disposed on a periphery of the display area, a pixel array disposed in the display area, and an identification area disposed in the non-display area, wherein a ruler coordinate configured to locate a two-dimensional barcode is disposed at a boundary of the identification area, and a target location in the identification area is provided with the two-dimensional barcode and an identity character separated from each other.

In the display panel of the present disclosure, a shape of the identification area is a rectangle, and a scale of the ruler coordinate is disposed on at least one side of the boundary of the identification area.

In the display panel of the present disclosure, the scale of the ruler coordinate is disposed on two adjacent sides of the boundary of the identification area.

In the display panel of the present disclosure, a scale of the ruler coordinate is disposed in the identification area.

In the display panel of the present disclosure, the scale of the ruler coordinate is separated from the identity character and the two-dimensional barcode.

In the display panel of the present disclosure, a scale of the ruler coordinate is disposed outside the identification area.

In the display panel of the present disclosure, the identity character includes at least two characters.

In the display panel of the present disclosure, the identity character includes a first character and a second character combined with each other, the first character is an English alphabet, and the second character is an Arabic numeral.

As described above, the present disclosure disposes the ruler coordinate for locating the two-dimensional barcode at the boundary of the identification area of the array substrate, and add identity characters in the identification area. In order to solve the problem that the offset of the two-dimensional barcode cannot be directly obtained, and whether the two-dimensional barcode is accurate and unpredictable is generated.

### DESCRIPTION OF DRAWINGS

In order to more clearly illustrate the embodiments or prior art technical solutions embodiment of the present disclosure, will implement the following figures for the cases described in prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a schematic view of an array substrate in the prior art.

FIG. 2 is a partial structural view of a non-display area of the array substrate in the prior art.

FIG. 3 is a schematic view of an array substrate according to a preferred embodiment of the present disclosure.

FIG. 4 is a partial structural view of a non-display area of the array substrate according to a preferred embodiment of the present disclosure.

FIG. 5 is a flowchart of a manufacturing method of the array substrate.

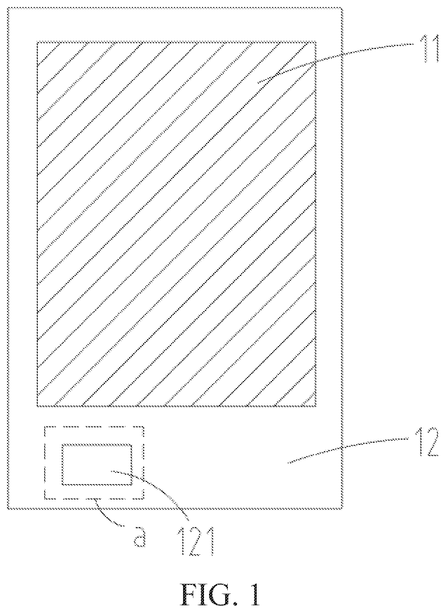

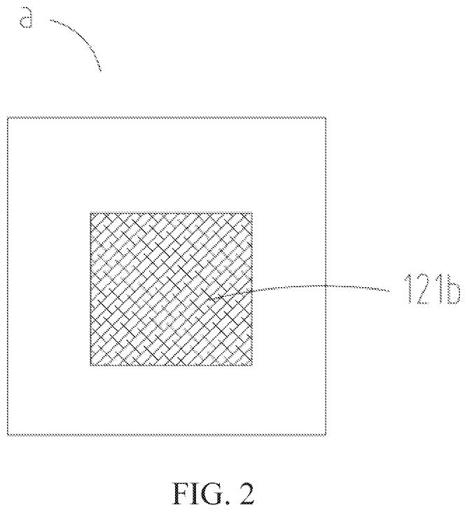

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

The present disclosure provides an array substrate and a manufacturing method thereof, and a display panel. In the existing array substrate, an offset of the two-dimensional barcode cannot be directly obtained. The problem of whether the two-dimensional barcode is accurate and unpredictable is generated. This embodiment can improve the drawback.

The present disclosure is further described below in conjunction with the drawings and specific embodiments:

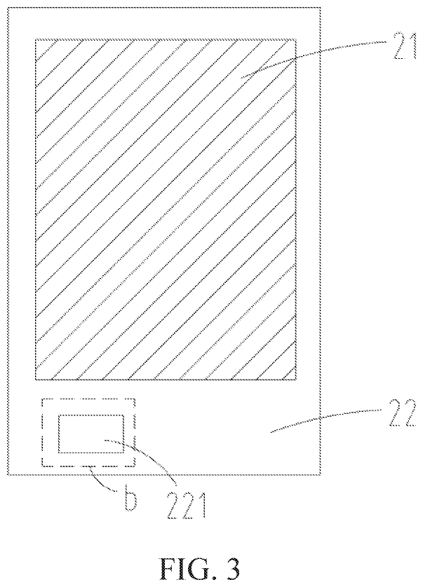

Referring to FIG. 3, a schematic view of an array substrate according to a preferred embodiment of the present disclosure is illustrated.

Referring to FIG. 4, a partial structural view of a non-display area of the array substrate according to a preferred embodiment of the present disclosure.

The present disclosure provides an array substrate, and the array substrate includes a display area 21 and a non-display area 22 disposed on a periphery of the display area 21.

A pixel array is disposed in the display area 21, and the display area 21 is a light emitting display area of the array substrate, and opposite to the display area 21 is a non-display area 22. Other areas such as signal routing areas, test areas, and control circuit areas are typically disposed within the non-display area 22.

In one embodiment, an identification area 221 is disposed in the non-display area 22. For understanding, the identification area and its surrounding area are circled and defined as area b in FIG. 3. A schematic view showing the structure of zone b in the present disclosure in FIG. 4. A ruler coordinate 222 is configured to locate a two-dimensional barcode 221b is disposed at a boundary of the identification area 221, and a target location in the identification area is provided with the two-dimensional barcode 221b and an identity character 221a separated from each other.

In the coding process of the existing array substrate, the offset of the two-dimensional barcode usually appears. During the production of a normal array substrate, the offset of the two-dimensional barcode needs to be adjusted. Usually, the two-dimensional barcode can only be replanted by manual measurement. This process is very error-prone. Therefore, it is necessary to adopt the technical solution in the present disclosure to solve the above problem.

In one embodiment, the ruler coordinate 222 for locating the two-dimensional barcode 221b is disposed at a boundary of the identification area 221, and the exact position of the two-dimensional barcode 221b in the identification area 221 can be directly read. After comparing with the predetermined location of the identification area 221, the location compensation amount of the two-dimensional barcode 221b can be directly obtained, and the location of the two-dimensional barcode 221b can be corrected to simplify the method for correcting the two-dimensional barcode. Furthermore, by adding an identity character 221a in the identity recognition area 221, the problem of repeated printing of the two-dimensional barcode in the identification area 221 is avoided.

In one embodiment, a shape of the identification area 221 is a rectangle, and a scale of the ruler coordinate 222 is disposed on at least one side of the boundary of the identification area.

In one embodiment, the scale of the ruler coordinate 222 is disposed on two adjacent sides of the boundary of the identification area 221, so that the location of the two-dimensional barcode can be obtained intuitively.

The interval of the scale of the ruler coordinate 222 can be flexibly disposed according to the size of the identification area, and is not limited herein.

In one embodiment, a scale of the ruler coordinate 222 is disposed in the identification area 221.

In one embodiment, in order to avoid the influence of the scale of the ruler coordinate 222 on the two-dimensional barcode 221b and the identity character 221a, the scale of the ruler coordinate 222 is disposed outside the identification area 221.

Considering the narrow bezel design of existing display devices, the identity character 221a cannot occupy too much space. Therefore, the identity character 221a includes at least two characters.

In one embodiment, the identity character 221a includes a first character and a second character combined with each other, the first character is an English alphabet, and the second character is an Arabic numeral. The identity character 221a is designed by two characters to intuitively determine the identity of the two-dimensional barcode, thereby saving the space occupied by the identification area, and facilitating the narrow frame design of the display device. In addition, the use of English alphabet and Arabic numeral can improve the recognition range of identity characters.

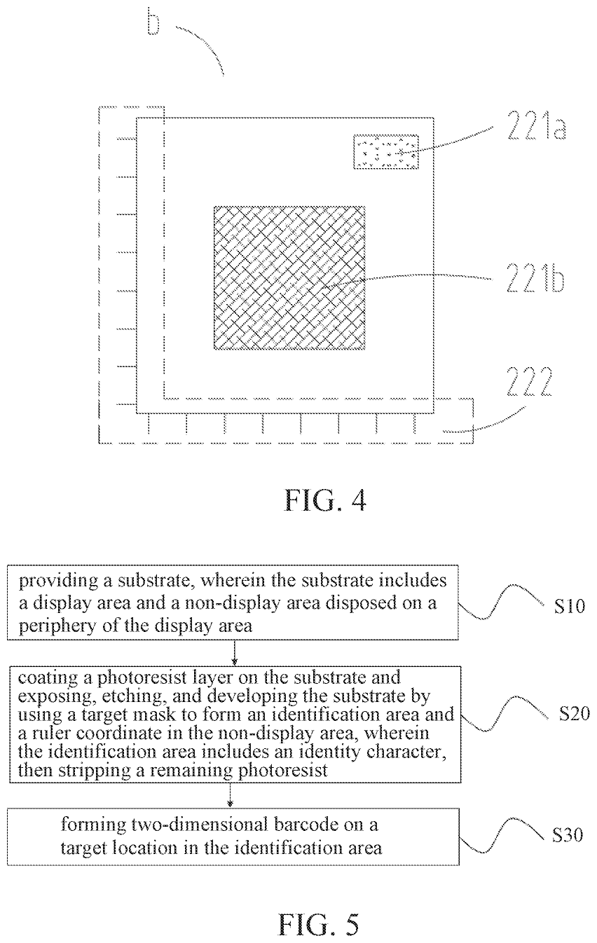

Referring to FIG. 5, a flowchart of a manufacturing method of the array substrate is illustrated.

According to another aspect of the present disclosure, a manufacturing method of an array substrate is also provided, wherein the structure of the array substrate can be referred to FIG. 3 and FIG. 4. The manufacturing method of the array substrate includes:

Step S10, providing a substrate, wherein the substrate includes a display area 21 and a non-display area 22 disposed on a periphery of the display area 21.

Step S20, coating a photoresist layer on the substrate and exposing, etching, and developing the substrate by using a target mask to form an identification area 221 and a ruler coordinate 222 in the non-display area 22, wherein the identification area includes an identity character 221a, then stripping a remaining photoresist.

Step S30, forming two-dimensional barcode 221b on a target location in the identification area 221.

A pattern on the target mask corresponds to a pattern of the ruler coordinate 222 and a pattern of the identity character 221a, and the ruler coordinate 222 is located at a boundary of the identification area 221.

The ruler coordinate 222 and the pattern of the identity character 221a can be prepared in the same mask process, thereby simplifying the process of making the ruler coordinate 222 and the identity characters 221a.

In one embodiment, the ruler coordinate 222 for locating the two-dimensional barcode 221b is disposed at a boundary of the identification area 221, and the exact position of the two-dimensional barcode 221b in the identification area 221 can be directly read. After comparing with the predetermined location of the identification area 221, the location compensation amount of the two-dimensional barcode 221b can be directly obtained, and the location of the two-dimensional barcode 221b can be corrected to simplify the method for correcting the two-dimensional barcode. Furthermore, by adding an identity character 221a in the identity recognition area 221, the problem of repeated printing of the two-dimensional barcode in the identification area 221 is avoided.

In one embodiment, a shape of the identification area 221 is a rectangle, and a scale of the ruler coordinate 222 is disposed on at least one side of the boundary of the identification area.

In one embodiment, the scale of the ruler coordinate 222 is disposed on two adjacent sides of the boundary of the identification area 221, so that the location of the two-dimensional barcode can be obtained intuitively.

The interval of the scale of the ruler coordinate 222 can be flexibly disposed according to the size of the identification area, and is not limited herein.

In one embodiment, a scale of the ruler coordinate 222 is disposed in the identification area 221.

In one embodiment, in order to avoid the influence of the scale of the ruler coordinate 222 on the two-dimensional barcode 221b and the identity character 221a, the scale of the ruler coordinate 222 is disposed outside the identification area 221.

Considering the narrow bezel design of existing display devices, the identity character 221a cannot occupy too much space. Therefore, the identity character 221a includes at least two characters.

In one embodiment, the identity character 221a includes a first character and a second character combined with each other, the first character is an English alphabet, and the second character is an Arabic numeral. The identity character 221a is designed by two characters to intuitively determine the identity of the two-dimensional barcode, thereby saving the space occupied by the identification area, and facilitating the narrow frame design of the display device. In addition, the use of English alphabet and Arabic numeral can improve the recognition range of identity characters.

The present disclosure disposes the ruler coordinate for locating the two-dimensional barcode at the boundary of the identification area of the array substrate, and add identity characters in the identification area. In order to solve the problem that the offset of the two-dimensional barcode cannot be directly obtained, and whether the two-dimensional barcode is accurate and unpredictable is generated.

The present disclosure has been described with preferred embodiments thereof and it is understood that many changes and modifications to the described embodiments can be carried out without departing from the scope and the spirit of the disclosure that is intended to be limited only by the appended claims.

What is claimed is:

1. An array substrate, comprising:
a display area;
a non-display area disposed on a periphery of the display area;
a pixel array disposed in the display area; and
an identification area disposed in the non-display area, wherein a ruler coordinate configured to locate a two-dimensional barcode is disposed at a boundary of the identification area, and a target location in the identification area is provided with the two-dimensional barcode and an identity character separated from each other.

2. The array substrate according to claim 1, wherein a shape of the identification area is a rectangle, and a scale of the ruler coordinate is disposed on at least one side of the boundary of the identification area.

3. The array substrate according to claim 2, wherein the scale of the ruler coordinate is disposed on two adjacent sides of the boundary of the identification area.

4. The array substrate according to claim 1, wherein a scale of the ruler coordinate is disposed in the identification area.

5. The array substrate according to claim 4, wherein the scale of the ruler coordinate is separated from the identity character and the two-dimensional barcode.

6. The array substrate according to claim 1, wherein a scale of the ruler coordinate is disposed outside the identification area.

7. The array substrate according to claim 1, wherein the identity character includes at least two characters.

8. The array substrate according to claim 1, wherein the identity character includes a first character and a second character combined with each other, the first character is an English alphabet, and the second character is an Arabic numeral.

9. A manufacturing method of an array substrate, comprising steps of:
S10, providing a substrate, wherein the substrate includes a display area and a non-display area disposed on a periphery of the display area;
S20, coating a photoresist layer on the substrate and exposing, etching, and developing the substrate by using a target mask to form an identification area and a ruler coordinate in the non-display area, wherein the identification area includes an identity character, then stripping a remaining photoresist; and
S30, forming two-dimensional barcode on a target location in the identification area;
wherein a pattern on the target mask corresponds to a pattern of the ruler coordinate and a pattern of the identity character, and the ruler coordinate is located at a boundary of the identification area.

10. The manufacturing method of the array substrate according to claim 9, wherein a shape of the identification area is a rectangle, and a scale of the ruler coordinate is disposed on at least one side of the boundary of the identification area.

11. The manufacturing method of the array substrate according to claim 9, wherein a scale of the ruler coordinate is disposed in the identification area.

12. The manufacturing method of the array substrate according to claim 9, wherein the identity character includes a first character and a second character combined with each other, the first character is an English alphabet, and the second character is an Arabic numeral.

13. A display panel, including an array substrate and a color film substrate oppositely arranged, wherein the array substrate comprises:
a display area;
a non-display area disposed on a periphery of the display area;
a pixel array disposed in the display area; and
an identification area disposed in the non-display area, wherein a ruler coordinate configured to locate a two-dimensional barcode is disposed at a boundary of the identification area, and a target location in the identification area is provided with the two-dimensional barcode and an identity character separated from each other.

14. The display panel according to claim 13, wherein a shape of the identification area is a rectangle, and a scale of the ruler coordinate is disposed on at least one side of the boundary of the identification area.

15. The display panel according to claim 14, wherein the scale of the ruler coordinate is disposed on two adjacent sides of the boundary of the identification area.

16. The display panel according to claim 13, wherein a scale of the ruler coordinate is disposed in the identification area.

17. The display panel according to claim 16, wherein the scale of the ruler coordinate is separated from the identity character and the two-dimensional barcode.

18. The display panel according to claim 13, wherein a scale of the ruler coordinate is disposed outside the identification area.

19. The display panel according to claim 13, wherein the identity character includes at least two characters.

20. The display panel according to claim 13, wherein the identity character includes a first character and a second character combined with each other, the first character is an English alphabet, and the second character is an Arabic numeral.
